(19) United States
(12) Patent Application Publication
(10) Pub. No.: US 2010/0175091 A1
(43) Pub. Date: Jul. 8, 2010

(54) System and Method of Providing a Source for Ordering a Plurality of Products from a Plurality of Media

(76) Inventors: Graeme Charles Revell, Hidden Hills, CA (US); Ashley Mark Revell, Studio City, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 12/646,587

(22) Filed: Dec. 23, 2009

Related U.S. Application Data
(63) Continuation-in-part of application No. 12/231,846, filed on Dec. 23, 2008.

(51) Int. Cl. G06Q 30/00; G06Q 50/00; H04N 5/445

(52) U.S. Cl. 725/60; 705/26

(57) ABSTRACT

Described herein is a method of providing a single source ordering products from a plurality of media to a user. The method includes the steps of providing a computerized electronic server that may be viewed on a device for ordering a plurality of products seen by the user viewing the media; providing a list of media based upon the geographic location of the user; and providing a means for selecting one or more media from the list of medial providing a list of products based upon the selected media.

### CROSS REFERENCE TO RELATED APPLICATIONS

This application is a continuation-in-part of U.S. patent application Ser. No. 12/231,846, filed Dec. 23, 2008, which is hereby incorporated by reference in its entirety.

### FIELD OF INVENTION

The present invention relates to a system and method of providing users a source of ordering a plurality of products from a plurality of media.

### BACKGROUND OF INVENTION

Often times, a person sees products he or she likes in a particular media he or she is watching. The person may not know the identity of the brand. Should the person not know the brand, for example, or the store where the product may be purchased, the person may have no way of ever obtaining that product. As such, there is a need for a system that allows people to purchase the product of interest by associating that product with the television show, for example, the product is a part of. Also, there is a need for a system that allows for people to purchase products while watching the media having the product.

### BRIEF SUMMARY OF THE PREFERRED EMBODIMENTS

In accordance with one aspect of the present invention, there is provided a method for providing a single source for ordering a plurality of products from a plurality of media. The method includes the steps of providing a computerized electronic server for ordering products; providing a means for selecting one or more media from a media list; providing a list of products based upon the selected media, wherein the computerized electronic server is assessable via a device. Preferably, the computerized electronic server is a website. Preferably, the list of media is associated with the geographic location of the user.

In accordance with another aspect of the present invention, a method of providing a single source for ordering a plurality of products seen by a user in a plurality of television shows or commercials by accessing a single computerized electronic server, is provided. The method includes providing a computerized electronic server for ordering products; providing a television service provider list; providing a channel list based upon the selected television service provider; and providing a product list based upon the selected channel, wherein the computerized electronic server is accessible via a device for ordering a plurality of products, and wherein the products are available for selection by the user as the user is watching the television show or commercial that contains the product of interest.

In accordance with another aspect of the present invention, a system of providing a single source for the purchase of a plurality of products seen by a user in one or more media as the user is viewing the media or anytime thereafter, is provided. The system includes a database of media and a database of products associated with the media. The system further includes a software system for selecting a plurality of products viewable in the media. Preferably, the software system provides a media list and provides a product list based upon the selected media. Preferably, the media list is based upon the geographic location of the user.

In accordance with another aspect of the present invention, a method for providing information regarding the purchase of a plurality of products from a reseller's website to a first website is provided. The method includes providing a first website for ordering a plurality of products, wherein the first website is accessible using a device capable of connecting to the Internet; displaying a plurality of resellers on the website; wherein each reseller's website is accessible from the first website via a link; collecting a data packet when a user is redirected to a reseller's website by clicking on the link; wherein the data packet includes information regarding the product of interest; the user's Internet Protocol address; and the date and time of the redirection; and, wherein the data packet of information is stored in the first website.

In accordance with another aspect of the invention, a method is provided. The method includes the steps of viewing a first particular media, viewing a first product within the first particular media, accessing a website via a device, wherein the first product is associated with the first particular media on the website, and purchasing the first product via the first website. In one aspect of this embodiment, a second product is associated with a second media on the website.

### BRIEF DESCRIPTION OF THE DRAWINGS

The invention may be more readily understood by referring to the accompanying drawings in which:

FIG. 1 is a block diagram of a system and method of providing a single source for the purchase of a plurality of products in accordance with a preferred embodiment of the present invention;

FIG. 2 is a block diagram of a computer system that may be used for implementing the system of providing a single source for the purchase of a plurality of products of FIG. 1 configured in accordance with a preferred embodiment of the present invention;

FIG. 3 is a network diagram illustrating a network of computer systems that may be used for implementing the system of providing a single source for the purchase of a plurality of products; configured in accordance with a preferred embodiment of the present invention;

FIG. 4 is a block diagram of the system and method of FIG. 1 wherein the products are selected from television shows and commercials and wherein a user may be accessing the website for the first time;

FIG. 5 is a block diagram of the system and method of FIG. 1 wherein the products are selected from television shows or commercials and wherein the user may have already logged into the website previously;

FIG. 6 is a block diagram of the system and method of FIG. 1 showing the subsequent steps conducted by the user to purchase the product of interest;

FIG. 7 is a block diagram depicting the system and method of FIG. 1 wherein the products are selected from live events;

FIG. 8 is a block diagram depicting the system and method of FIG. 1 wherein the products are selected from feature films;

FIG. 9 is a block diagram depicting the system and method of FIG. 1 wherein the products are selected from billboards;

FIG. 10 is a block diagram depicting the system and method of FIG. 1 showing steps conducted by a producer to enter products into the system, wherein the producer may be starting a new product list;

FIG. 11 is a block diagram depicting the system and method of FIG. 1 showing steps conducted by a producer to enter products into the system, wherein the producer may be opening a new product list;

FIGS. 12-20 are screen shots depicting the system and method of FIG. 1;

FIG. 21 is a block diagram depicting the system and method of FIG. 1 showing the steps whereby a producer of an on-line video may associate products with the on-line video;

FIG. 22 is a block diagram depicting the system and method of FIG. 1 showing the steps whereby a producer may associate products with media;

FIG. 23 is a block diagram depicting the system and method of FIG. 1, showing steps whereby reseller may add products to the product database;

FIG. 24 is a block diagram depicting the system and method of FIG. 1, showing steps whereby the user, reseller, and/or producer may search media and/or browse media; and

FIG. 25 is a block diagram depicting the system and method of FIG. 1, showing the steps that may be taken by the administrator of the website of the present invention.

### DETAILED DESCRIPTION OF THE PREFERRED EMBODIMENTS

According to the present invention, a system and method for providing a single source for ordering a plurality of products from a plurality of media (also referred to herein as “system and method of providing a single source for the purchase of a plurality of products seen by a user in one or more media or anytime thereafter”) is provided. As used herein, “plurality” means “one or more.” As used herein, “products,” or any grammatical variation thereof, refers to services, goods, and/or any item, tangible or not, that is capable of being purchased.

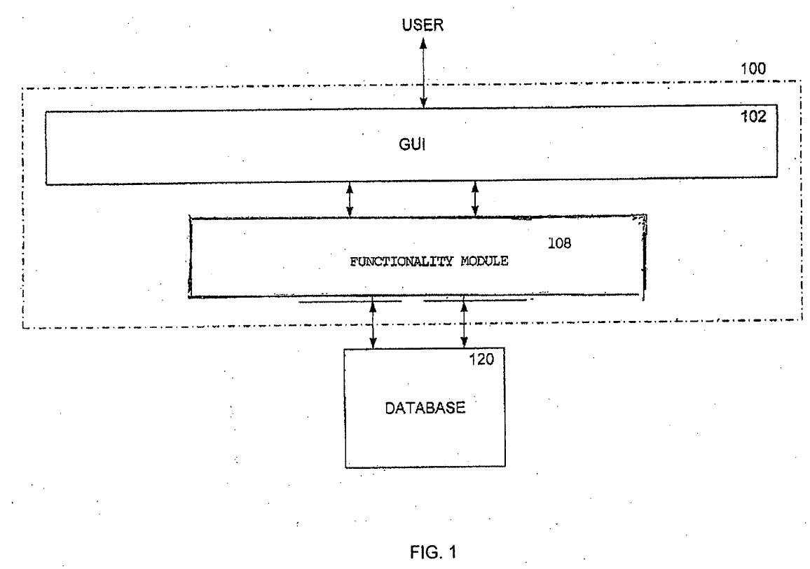

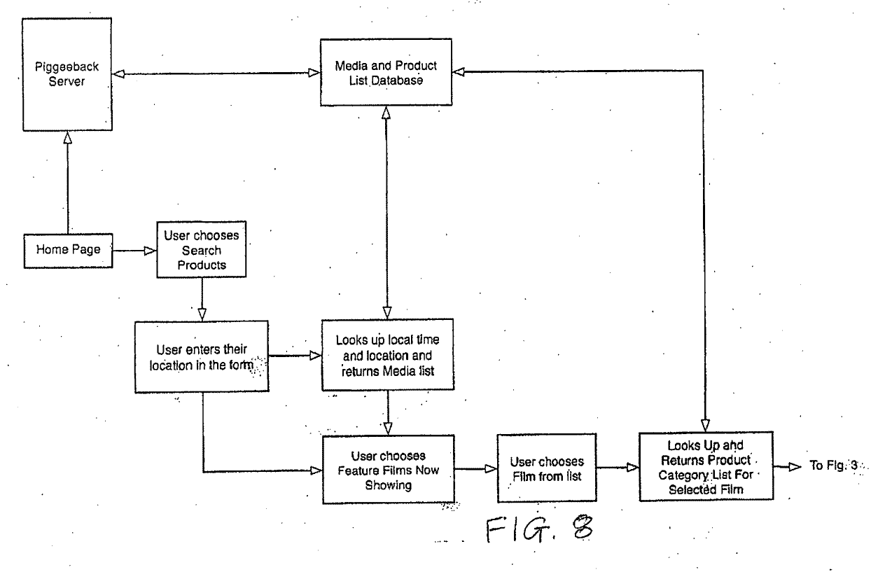

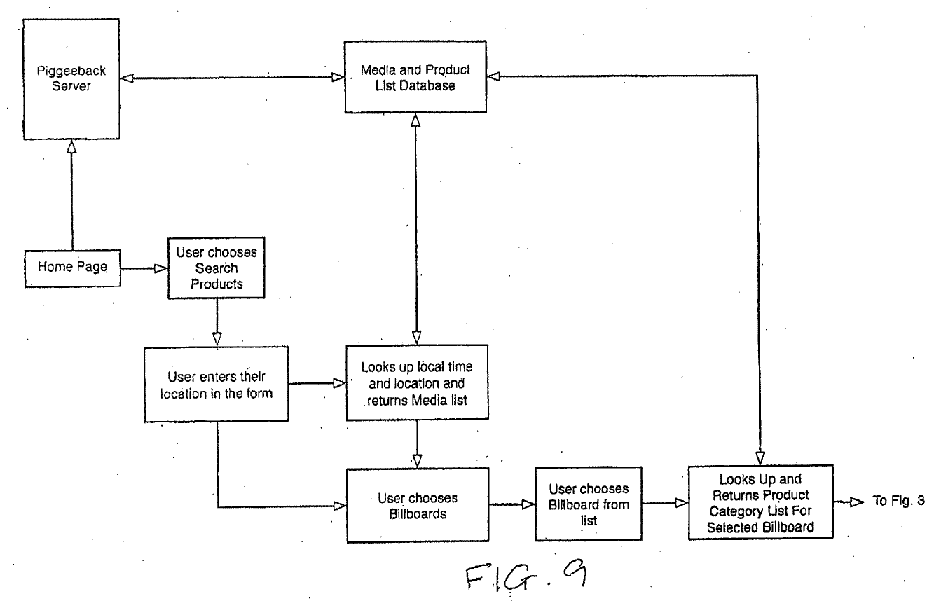

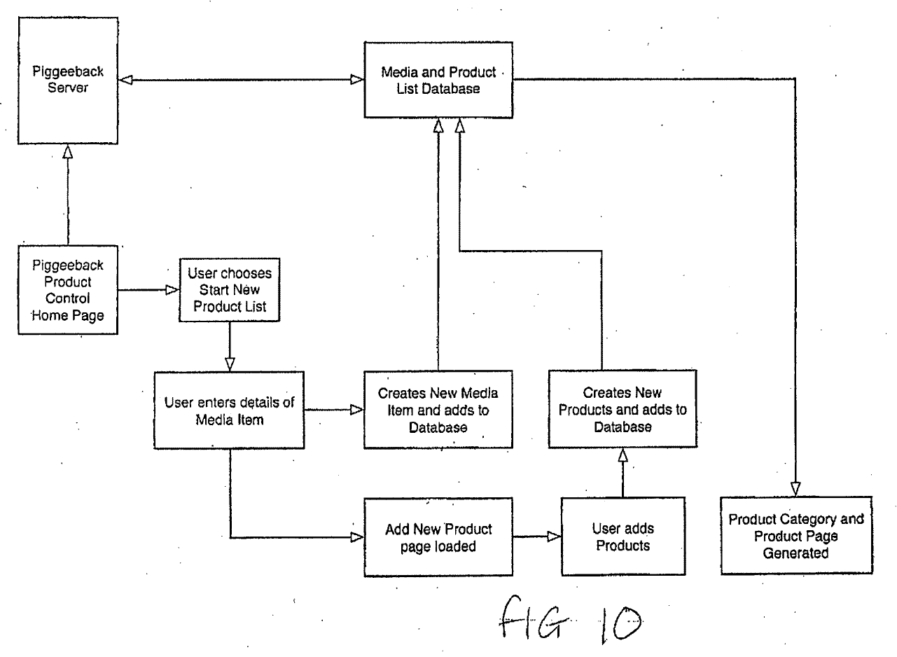

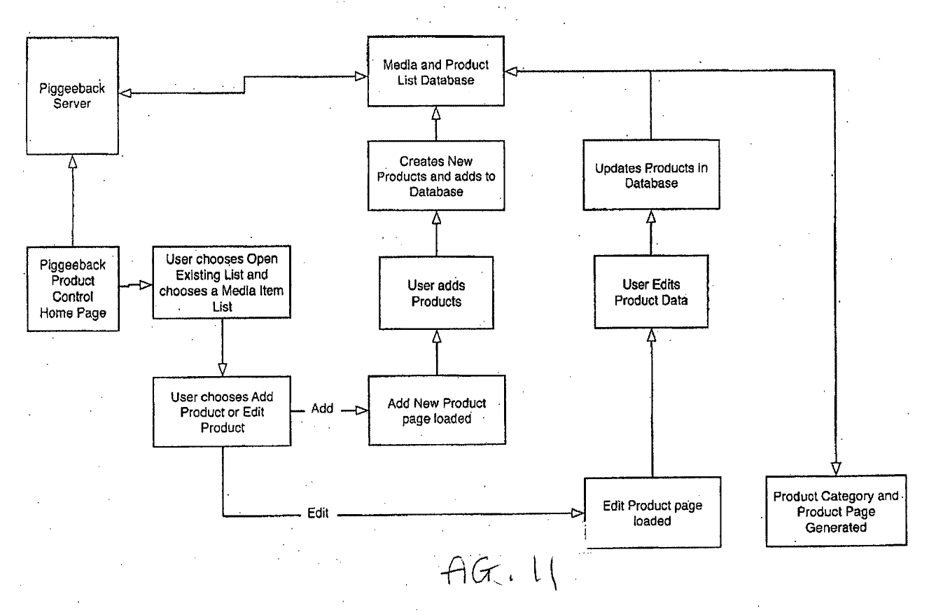

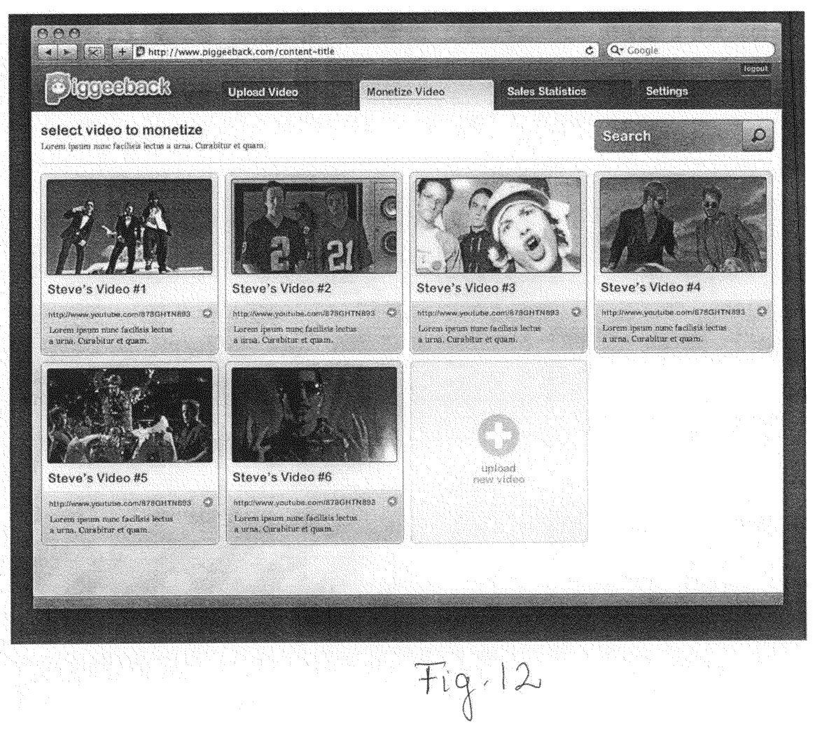

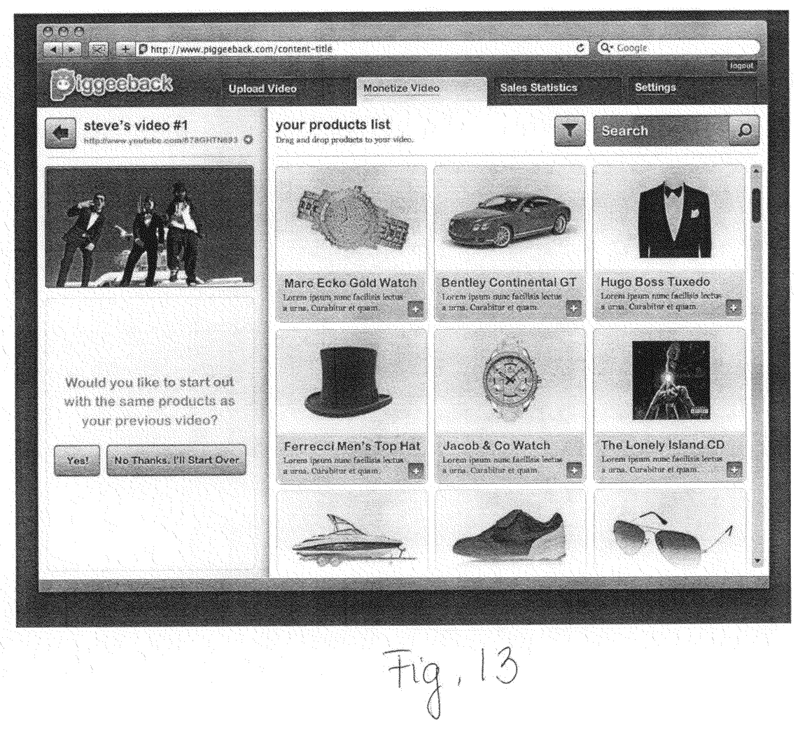

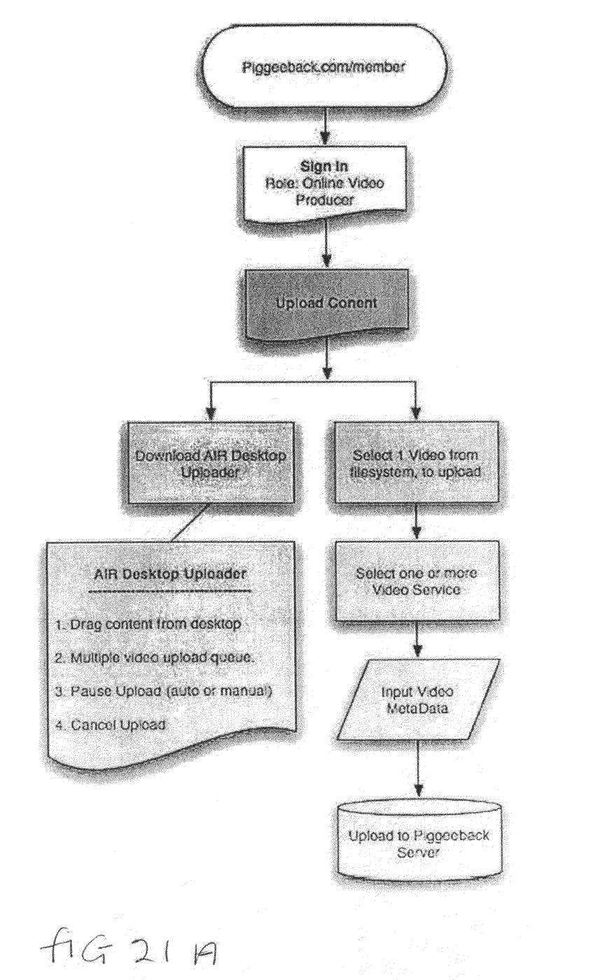

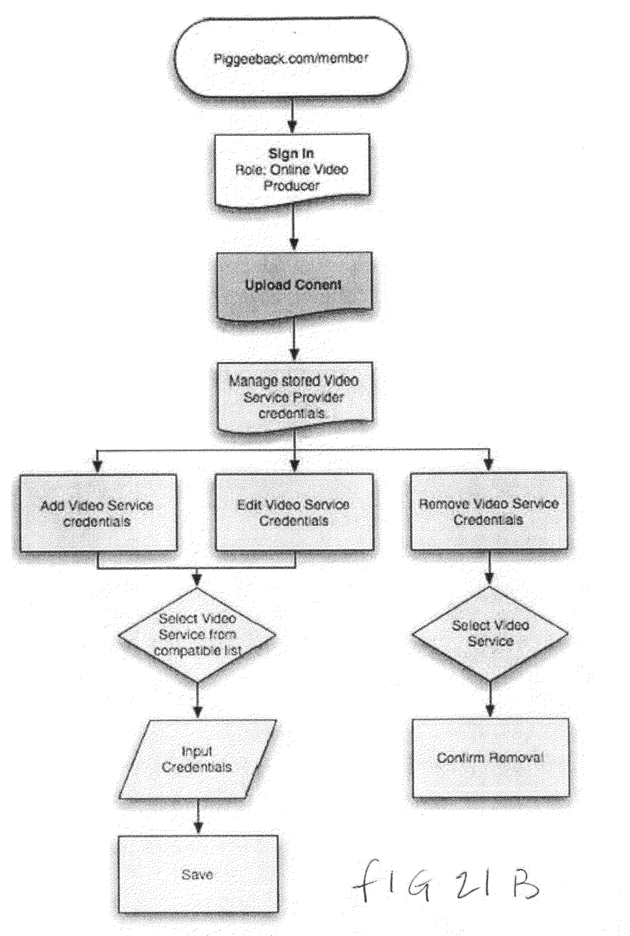

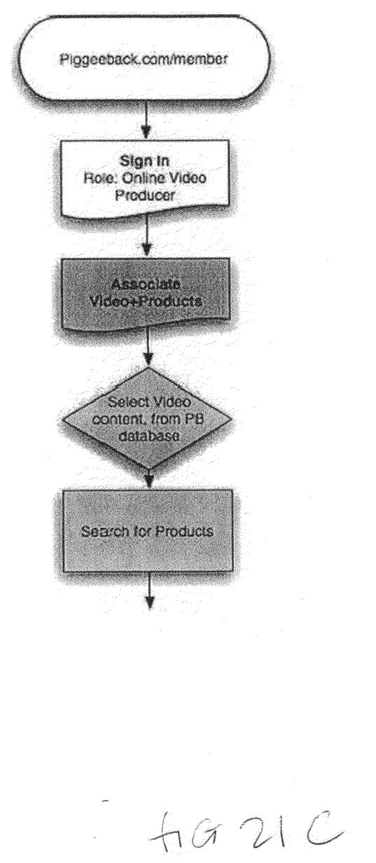

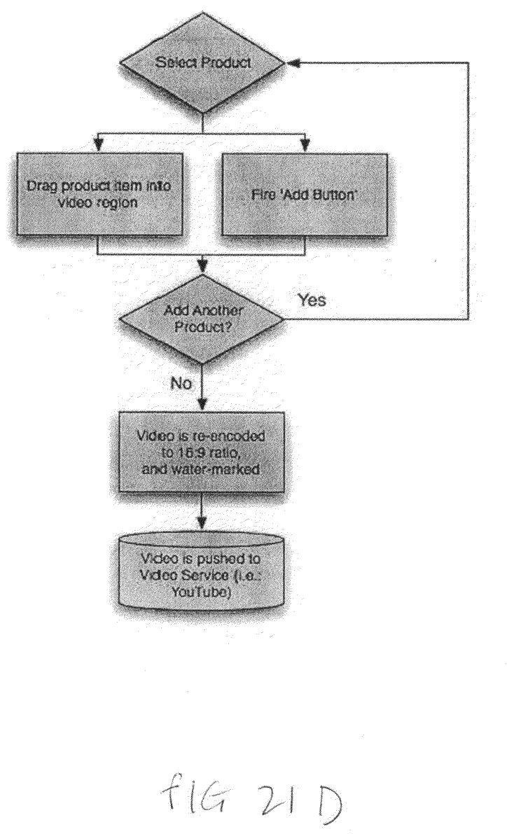

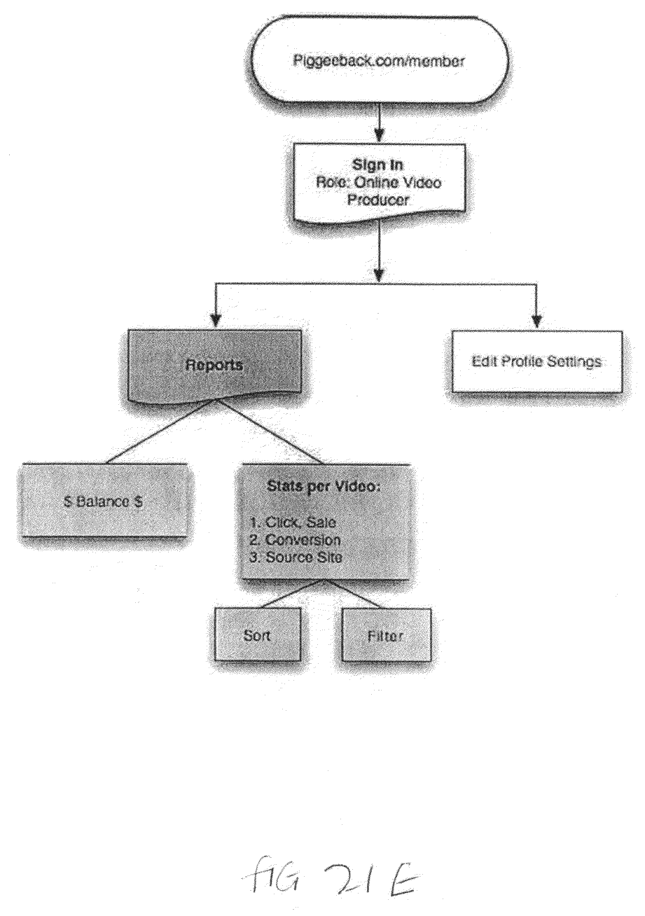

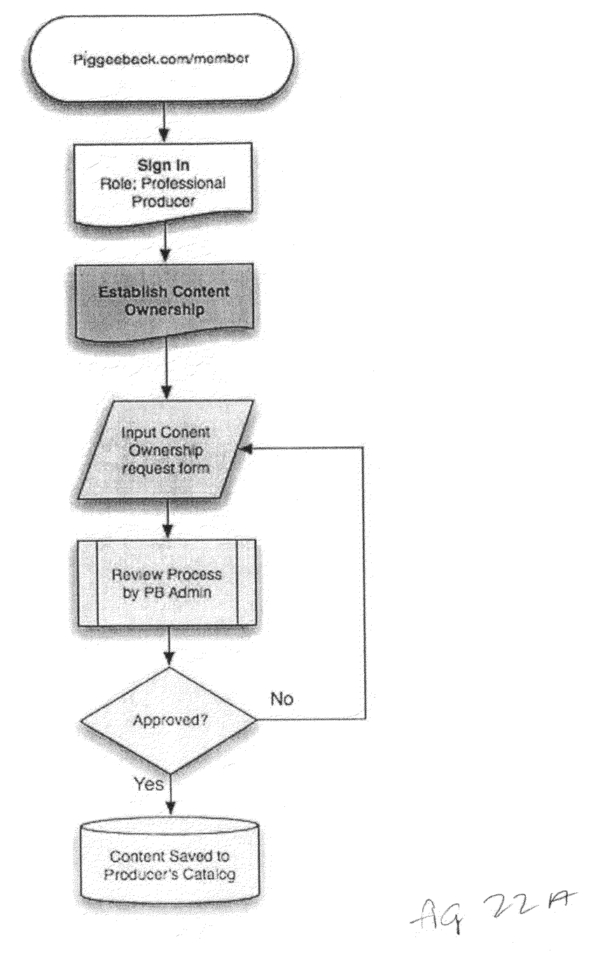

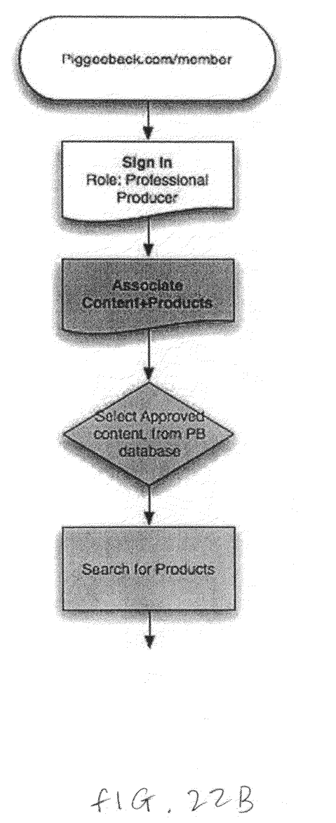

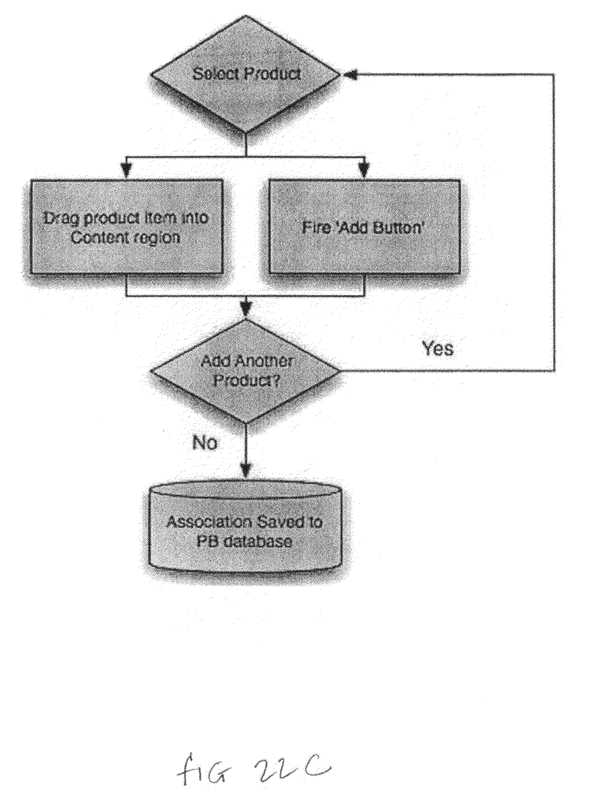

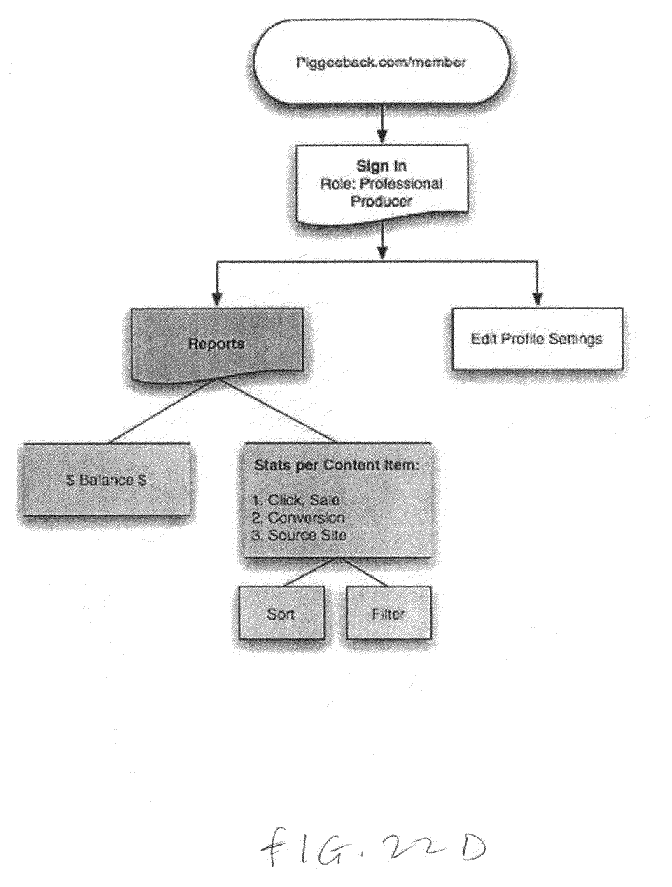

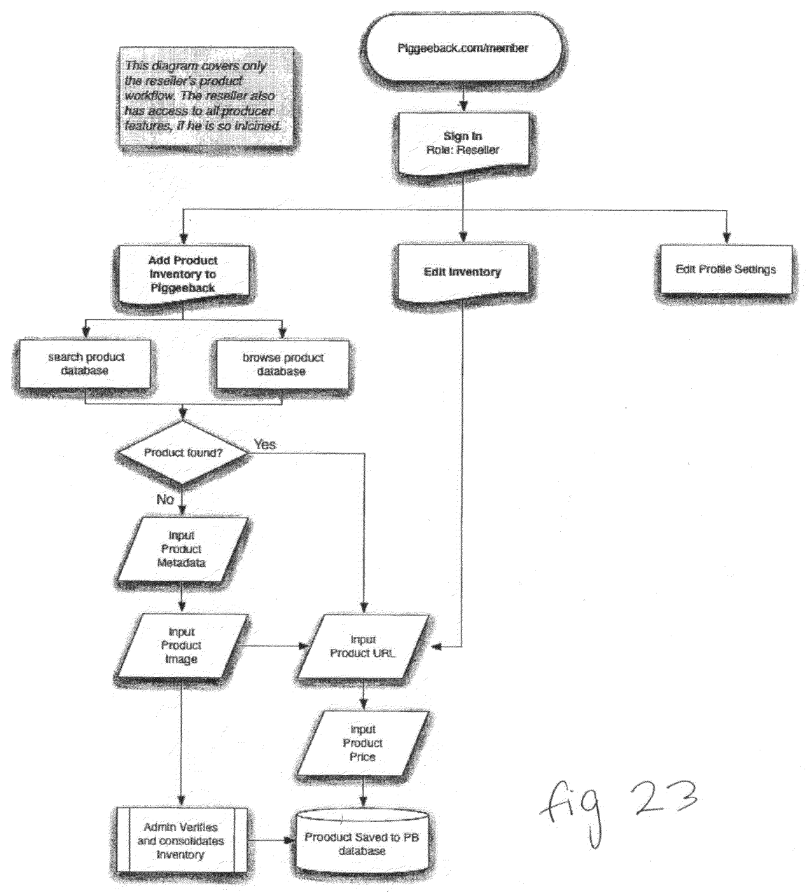

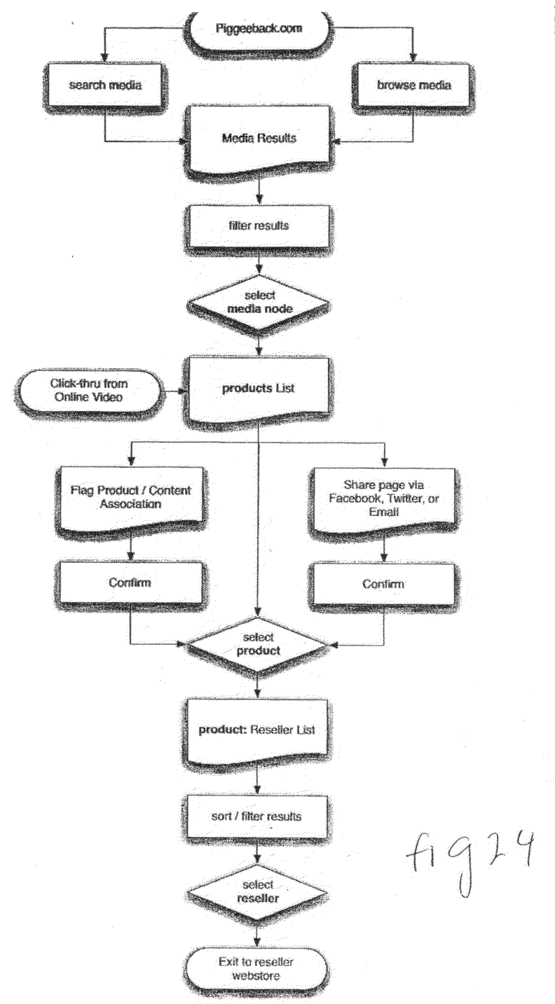

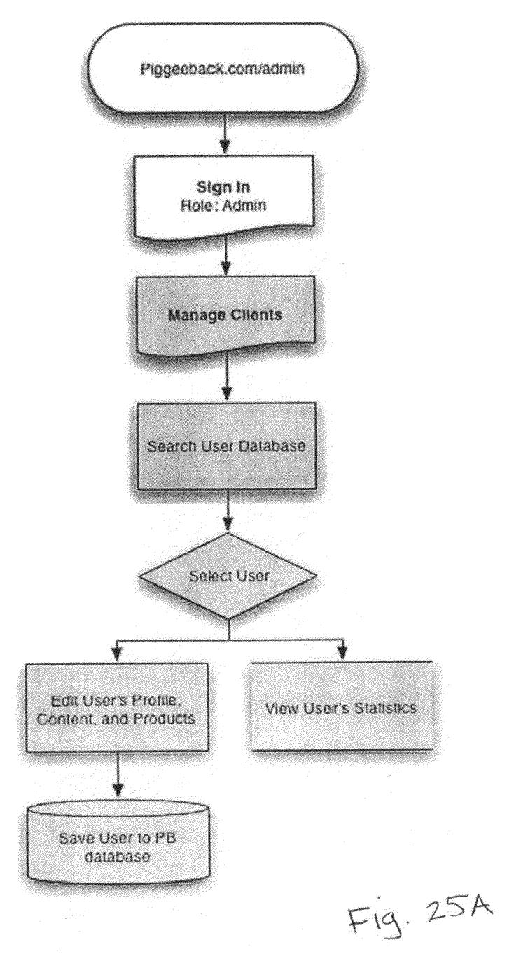

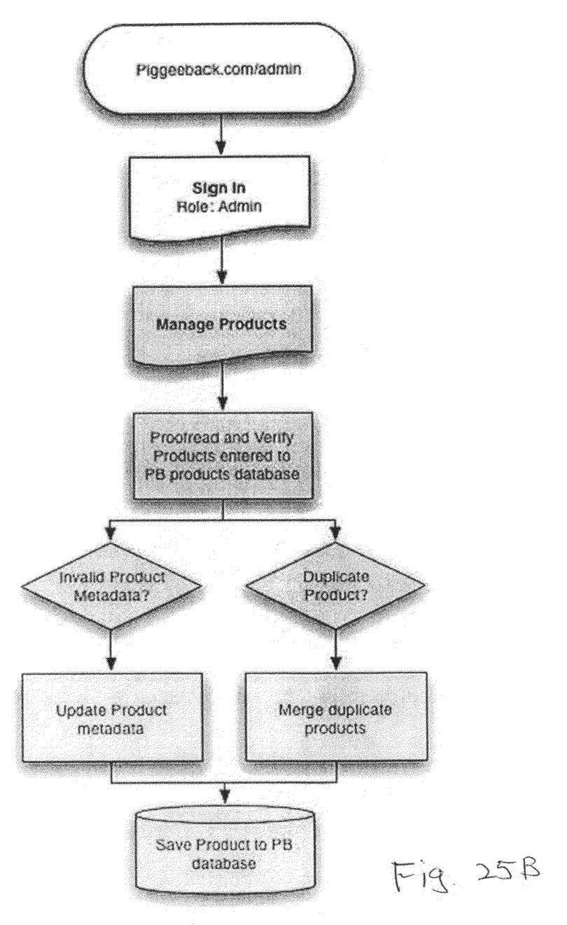

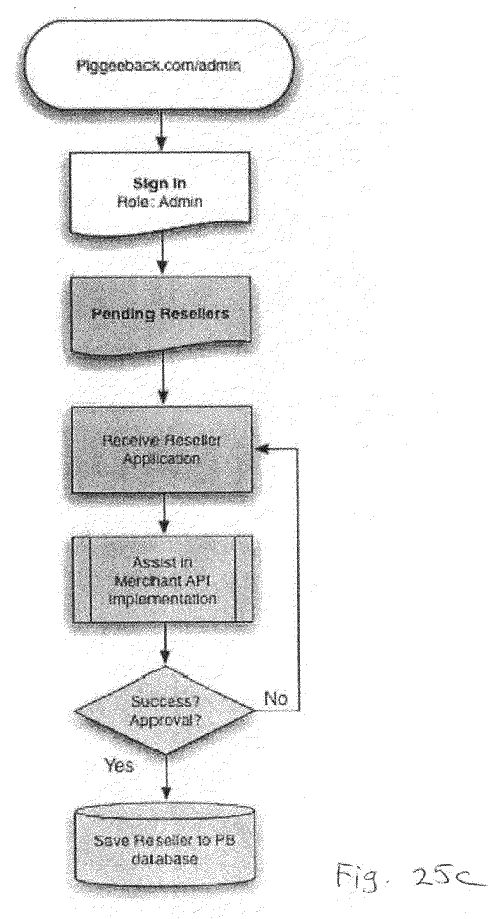

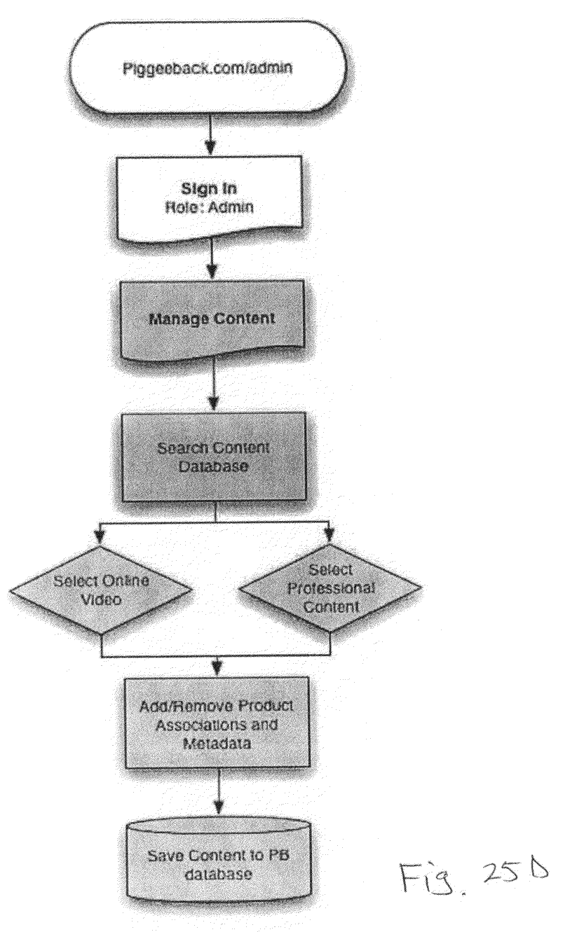

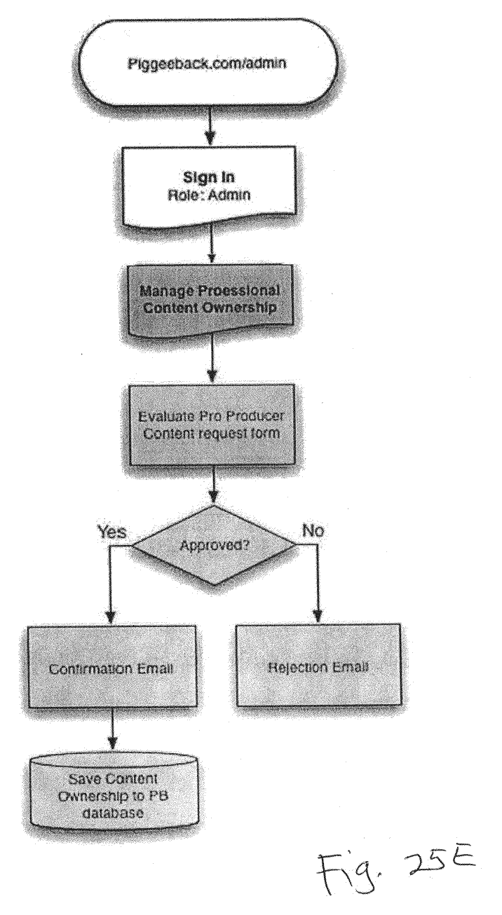

Referring to FIGS. 1-25, the present invention is directed to a system and method of providing a viewer of media a single source for purchasing a plurality of products. Preferably, the viewer is able to purchase the product of interest by using a device capable of connecting to an electronic server. As used herein, “computerized electronic server” or “electronic server” refers to a website, such as an Internet website and/or electronic commerce system and/or any other electronic system capable of electronic commerce. It may also refer to a local area network, cell phone networks, or any electronic commerce system. Preferably, the viewer is able to purchase the product of interest in real time, i.e., as the viewer is watching the show that includes the product of interest. As used herein, “device” may refer to a computer, cell phone, smart phone, hand-held electronic device, personal digital assistant, remote control, television set, set top box, HD TVs, mobile networks, phone, data, photographic scanning systems, mobile video, mobile networks, phone, data, photographic and scanning systems; or any other device for viewing an electronic system or server such as a website.

FIG. 1 is a block diagram of a system 100 for providing a single source for ordering a plurality of products from a plurality of media. The system 100 includes a graphical user interface (GUI) 102 coupled to a functionality module 108. The GUI 102 provides a person with access to the information stored in a database 120 using the functionality provided by the functionality module 108. Further, as described below, in one preferred embodiment, the database 120 stores information in one or more related databases that are logically grouped by predetermined areas. These areas may be, for example, user databases, media databases, product databases, etc. As used herein, “database” should be understood to cover reference to a single database or a collection of databases. It is to be understood that information may be stored or arranged using a variety of data storage software and hardware techniques known to those of ordinary skill in the art in database programming. For example, one database system that may be used with the present invention is the SQL Server system as offered by Microsoft Corp. Other data storage systems, such as those based on Oracle Database products offered by Oracle Corporation or the MySQL database server offered by MySQL AB, may be used. These data storage systems run on a variety of hardware platforms, including those based on the microprocessors offered by Advanced Micro Devices2, Inc., or Intel Corp. In addition, the inventive system may include a software system for (i) providing a media list based upon geographic location of the user; (ii) providing a product list based upon selected media; and (iii) entering product information and associating the product information with a particular media.

Still referring to FIG. 1, the database 120 is preferably accessible by the functionality provided by the functionality module 108. The user accesses the functionality module 108 through the GUI 102, as described herein, which is described through a series of exemplary flow diagrams. In a preferred embodiment, the functionality module 108 includes means for: providing a media list based upon geographic location of the user; providing a producer list based upon selection of a media; purchasing the product of interest; associating products with particular media; and entering the products into the system.

In a preferred embodiment, the data generated by the functionality module 108 and/or software system may be exported and/or imported into other applications or sites, or off-line, in any way the person needs. For example, the data generated may be exported and/or imported in order to generate reports, as back-up, or to process the data in any way.

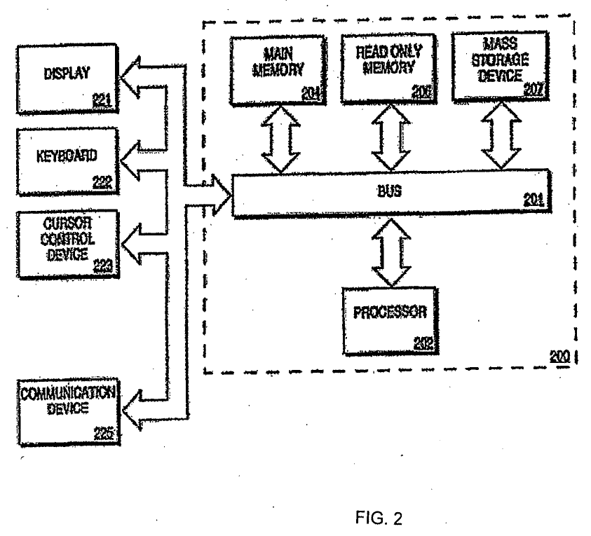

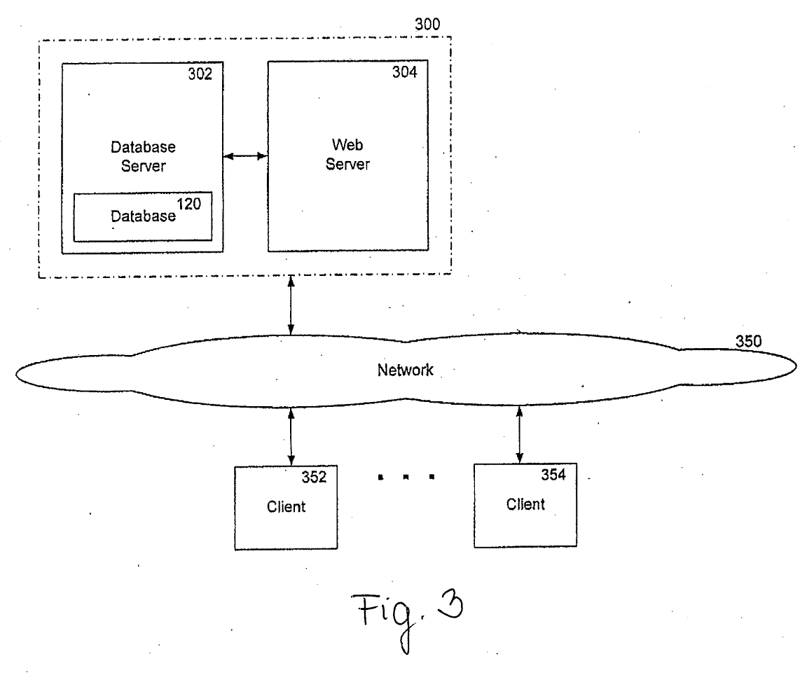

FIG. 2 illustrates an example of a computer system 200 in which the features of the present invention may be implemented. The computer system 200 includes a bus 201 for communicating information between the components in the computer system 200, and a processor 202 coupled with the bus 201 for executing software code, or instructions, and processing information. The computer system further comprises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during the execution of instructions by the processor 202. The computer system 200 also includes a read only memory (ROM) and/or other static storage device coupled to the bus 201 for storing static information and instructions for processor 202.

Another type of user input shown in the figure is a cursor control device 223, such as a conventional mouse, touch mouse, trackball, track pad, or other type of cursor direction keys for communicating direction information and command selection to the processor 202 and for controlling movement of a cursor on the display 221. Although not illustrated, the computer system 200 may optionally include video, camera, speakers, sound card, and many other conventional multimedia options. Various types of input devices, including, but not limited to the input devices described herein, unless otherwise noted, allow the person to provide command or input to the computer system 200. For example, in the various descriptions contained herein, reference may be made to the user “selecting,” “clicking,” or “inputting,” any grammatical variations thereof, one or more items in an interface. These should be understood to mean that the person is using one or more input devices to accomplish the input. Additionally, as used herein, “selecting” or any other grammatical variation thereof, may be interchangeable with “entering.”

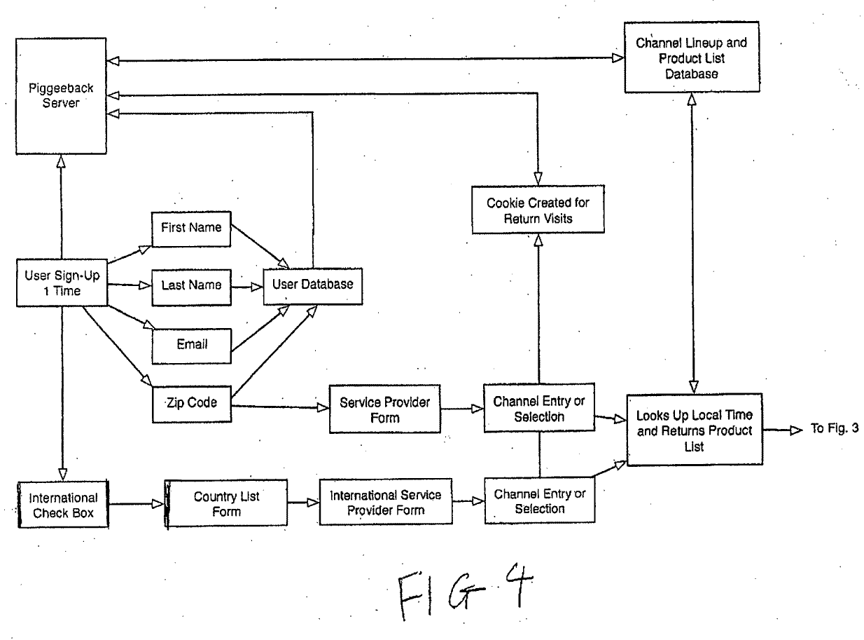

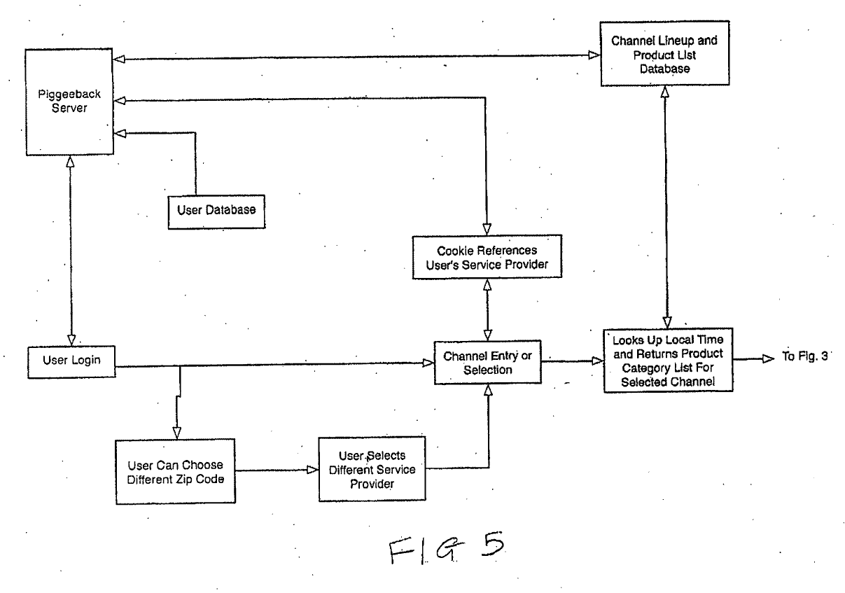

FIG. 3 illustrates a computer network including a server system 300 having a database server 302 for storing a database 120 and a web server 304 that stores the instructions necessary to access and present the information from, as well as store information into, the database 120. The user, using a client computer such as a client 352 and a client 354, accesses server system 300 through a network 350. Other systems, such as those belonging to a manufacturer may also be coupled to the server system 300. In the illustrated embodiment, the network 350 represents a variety of networks that may include one or more local area networks as well as wide area networks. The functionality provided by the database server 302, the web server 304, the client 352 and the client 354, as well as by the manufacturer may be implemented using a computer system having the characteristics of the computer system 200 described herein. It should be noted, however, that the specific implementation of the computer system or systems used to describe the present invention is not to be limiting unless otherwise specifically noted. For example, the functionality provided by the database server 302 and the web server 304 may be offered by one computer system. Further, the functionality provided by the database server 302 and 304 may be redistributed over several computers.

As described above, and referring to FIGS. 1 and 3, the user may interact with the information stored in the database 120 through the GUI 102. In the following description, the GUI 102 may be implemented using one or more web pages (which may be referred to herein as “pages,” “screens,” or “forms”) provided by the web server 370 accessible by the user using any Internet web browser software, such as Internet Explorer browser provided by Microsoft Corp., on a computer such as computer 330 or computer 340. In another embodiment, one or more custom software programs can be created to implement the system described herein. Of course, the web server 370 may itself have browser software installed on it so as to be accessed by the user. Further, throughout the description of the various embodiments of the invention herein, references are made to the user performing such actions as selecting buttons or clicking on, executing searches or updates on the database 120. In one preferred embodiment, these requests are generated by the user interacting with the browser. Preferably, the one or more web pages described herein may include a form interface (e.g., a drop down menu, a radio button selection, etc.). Once the user has provided such a selection, the person may select a button or a link on the web page to request an update of the database 120 with the information. The browser will send the web server 370 a link that includes the information (i.e., the user's selection) being sent as well as the request to update the database 120.

In a preferred embodiment, the present invention operates briefly as follows. A user (“also referred to herein as a “viewer”) views a particular media, such as a feature film, for example. The user sees a jacket that one of the actors is wearing in the film, and wishes to purchase it. The user accesses a device capable of displaying a computerized electronic server, such as a website, while at the theater. The user may purchase the product from a product list displayed based upon the particular film. In a like manner, a producer may enter products for sale on the website by associating the products, for example, with the feature film they are contained in, allowing users to purchase the products associated with the film.

In a preferred embodiment, as used herein, a person who offers products for sale on the website is referred to herein as “producer” or “reseller,” (further described below). As used herein, “producer” also refers to an individual, corporation, or other entity who creates the media and/or who adds products to the product database and/or associates products in the product database with that media. A producer may or may not be the creator of the media.

Preferably, as used herein, “media” (without being preceded by “particular”) refers to categories of media, such as, but not limited to, one or more of the following: television show or commercial, live event, feature film, DVD, video, printed media, video game; mobile networks, phone, data, photographic and scanning systems; mobile videos and photographic systems and/or aerial displays. Preferably, the categories of media may be described in any way, and are not limited to the foregoing names, as the foregoing categories of media are exemplary. For example, “television show” and “commercial” may be separate categories, or identified with a different name, such as a program. As used herein, “particular Media” or “first particular media” refers to the specific show, event, or the like. In other embodiments, “media” may refer to any medium that depicts goods or services capable of being purchased.

In a preferred embodiment, and referring to FIGS. 1-25, a user may purchase a plurality of products from a plurality of media by accessing a single source, i.e., a single website. As used herein, “single source” may refer to a single website, a single computerized electronic server, or the like. For example, the inventors contemplate use of a single website, “piggyback.com” wherein users may purchase products from one or more different media. For example, users may purchase products from movies, video games, and commercials all by accessing the piggyback.com website. In other embodiments, products from different types of media may be accessible via different sources, such as different websites. For example, the user may access one website for purchasing products viewed in a television show or commercial, and may access another website for purchasing products viewed in a live event. In this manner, one website may cater to one or more categories of media, and the other may cater to different media.

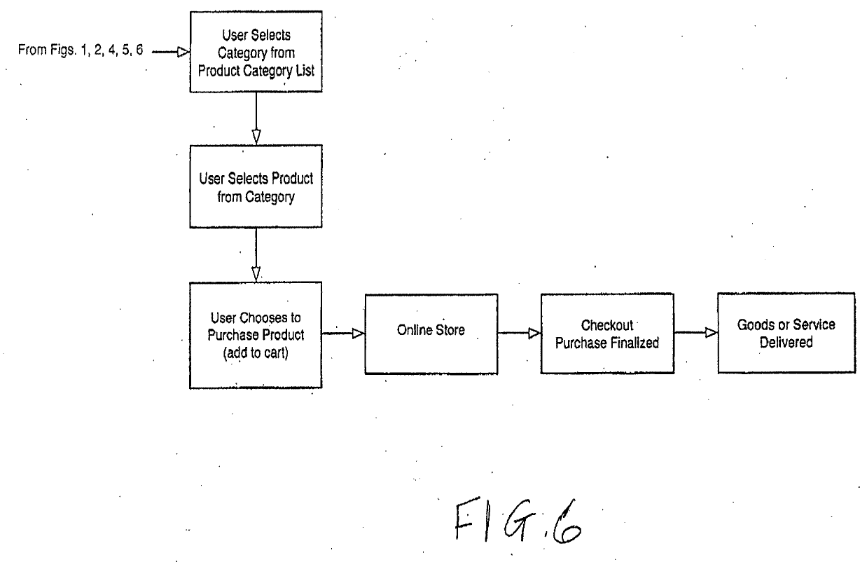

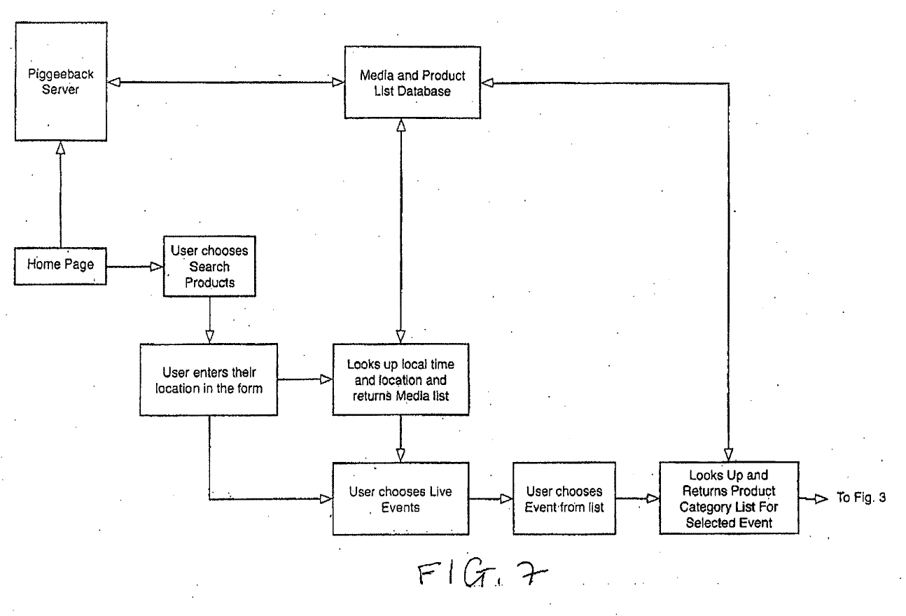

In a preferred embodiment, the user accesses the website in the following manner. Preferably, and as best depicted in FIGS. 4 and 7-9, should the user be accessing the website for the first time, the user may be directed to a SIGN IN or LOG IN page which directs the user to enter his or her name, geographic location, and the like. In subsequent visits, and as is best seen in FIG. 5, preferably, the user is not required to enter this information, as it is stored in the server, user database, or the like. In other embodiments, the user may not need to input a log in and/or password and/or the homepage may have another means for registering a new user.

In a preferred embodiment, and as best depicted in FIGS. 7-9, the user is prompted to either enter his or her current geographic location, or the geographic location where the media was shown. A media list based upon this geographic location is displayed on the website. Preferably, the media list is also based on a local time at the location of the user. As used herein, “local time” refers to the time at the user's location. As such, the media list is preferably comprised of media that is “happening” at the time that the user is accessing the website. For example, based upon the geographic location and local time of the user, the media list may include, for example, a live event such as a concert occurring at the time the user is accessing the website. However, the user may enter another time, i.e., the user may enter a time that the event, for example, having the product of interest, was viewed. This may be after the event took place. In this manner, the viewer may purchase products that were seen in a particular media at an earlier point in time. In other embodiments, the media list provided or displayed is not based upon geographic location and/or local time. In yet other embodiments, the user's geographic location is automatically determined by the system.

In a preferred embodiment, the user selects a plurality of media of interest from the media list. Preferably, upon selection of a media from the media list, one or more sub-lists may be provided. These sub-lists may be sub-categories of media or a list of one or more particular media. For example, another list having specific events or shows, or specific names of the printed matter, are displayed. For example, should printed media be selected, then specific billboards, i.e., located at or near the geographic location of the user, may be displayed. In yet other embodiments, upon selection of a media from the media list, one or more additional sub-lists are not provided.

In a preferred embodiment, the selected media may dictate subsequent steps of the invention. For example, should the selected media be “television show or commercial” or any other media category identifying television as the media, then the user may either be provided with a list of television service providers based upon geographic location and/or will be able to enter a television service provider. As best seen in FIG. 4, preferably, upon selection of a television service provider, a channel list is displayed and/or the user may be able to enter a channel of interest. Preferably, upon selection of a channel, a program list may be displayed. A program may be selected by selecting a title from the program list and/or the user may be able to enter the title in the website. A product list may be displayed based upon the selected program. In other embodiments, upon selection of a channel, i.e., “CSI Miami” a product category list is displayed based upon the local time and the selected channel.

In a preferred embodiment, regardless of the media selected, a product category list is displayed as seen in FIG. 6. Preferably, the product category list displayed varies with the media selected. For example, should the media selected be “television show or commercial,” then the product category list includes a choice of “in the show” or “in the commercials” and the user may select from one of the foregoing. In other embodiments, no product category list is provided. Rather, one or more product lists are displayed based upon the selected media and/or selected sub-media.

In a preferred embodiment, and as best seen in FIG. 6, upon selection of a product category, a product list is displayed. Preferably, and as best seen in FIG. 6, the user is able to select a plurality of products from the product list. Preferably, upon selection of a plurality of products from the product list, one or more reseller lists are provided. As used herein, “reseller” may be a “producer”, an individual, corporation, vendor, or other entity that has its products for sale on the website, or a separate website. For example, a reseller may be a manufacturer, distributor, store owner, or the like. In other embodiments, upon selection of a plurality of products from the product list, a reseller list is not provided. Rather, the user may purchase the product of interest directly from the website.

In a preferred embodiment, upon display of a reseller list, the user may select a reseller. Preferably, selection of a reseller by clicking on the reseller's link directs the user to the reseller's website. At some point during the redirection, a data packet is collected. That data packet may include information identifying the product of interest; the user's Internet Protocol address; the date and time of the redirection, and the like. Preferably, the product information includes the products unique identification number. This data packet is preferably stored in the website (also referred to herein as “first website” in order to differentiate it from the reseller's website). Preferably, the reseller's website notifies the first website when the user purchases the product of interest. Accordingly, not only is the user's clicking of the link to the reseller's website tracked, but so is the user's purchase, should a purchase be consummated. In other embodiments, selection of a reseller does not direct the user to the reseller's website. Rather, the user may purchase the products directly from the website without being redirected. In yet other embodiments, the data packet is not stored in the first website upon redirection; rather, should the user click the link and be redirected from the first website to the reseller's website, and should the user subsequently purchase the product of interest, then the first website may be notified of the purchase.

In a preferred embodiment, the use of the purchase notification system described above is used to track purchases through the website of the present invention. In other embodiments, the purchase notification system may be used with any other websites and does not need to be associated with the website of the present invention.

In a preferred embodiment, the user, producer, and/or reseller may be able to search the product database by entering product information, such as, but not limited to, product identification, product identification number, product description, and/or the particular media that the user saw the product of interest in. As such, media information does not need to be entered to search product of interest.

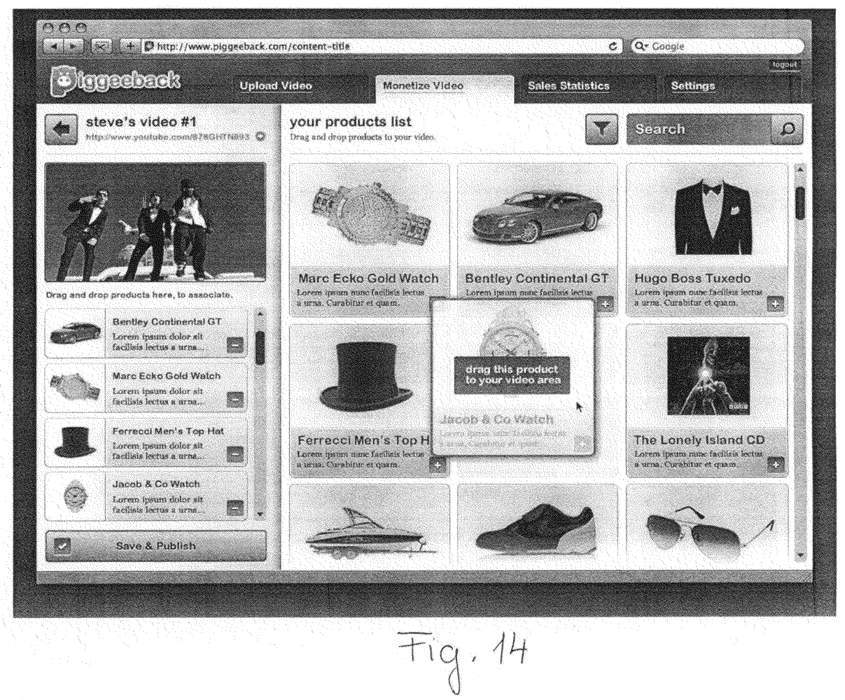

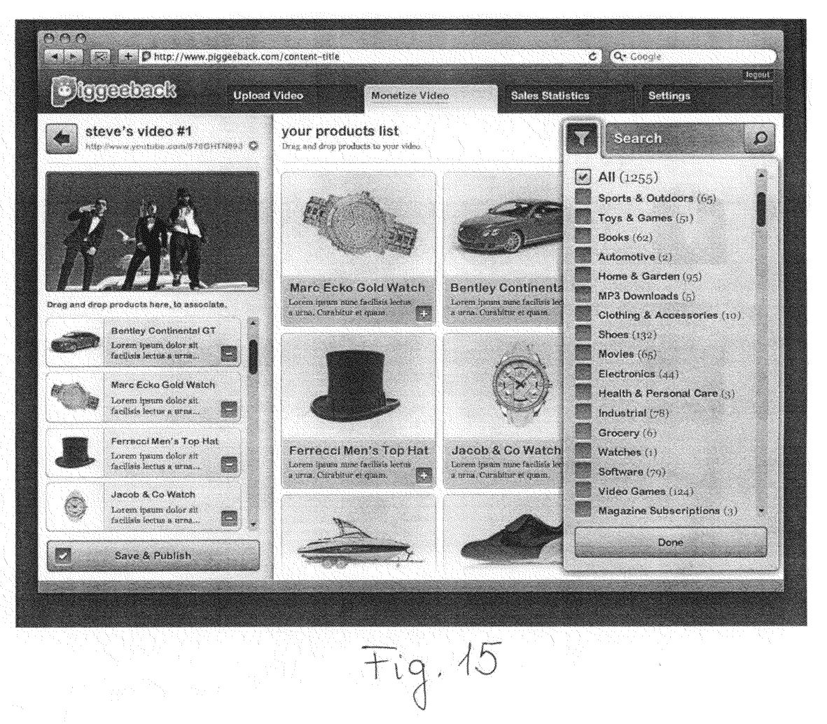

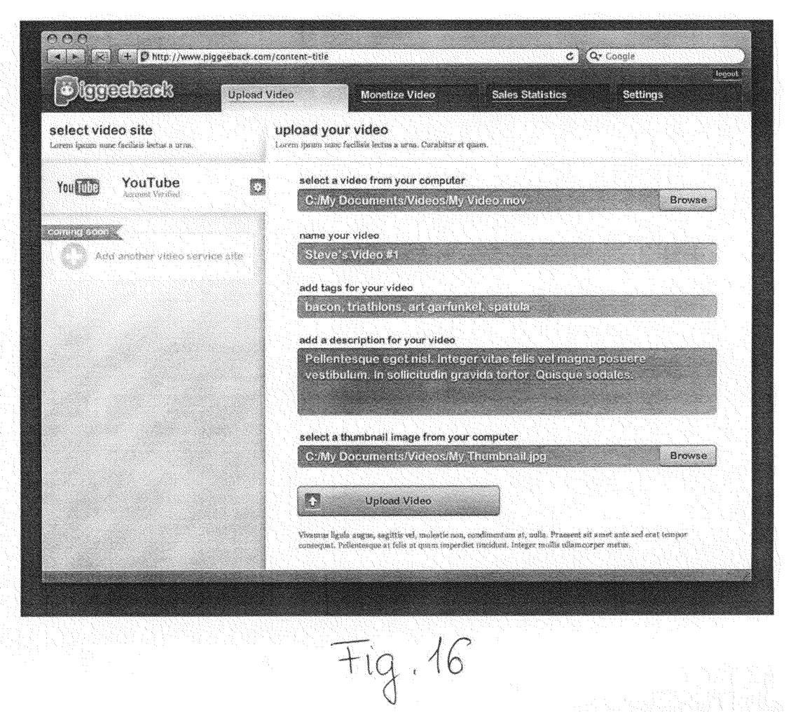

In a preferred embodiment, and referring to FIGS. 10, 11, and 22, the producer adds a product to the product database in the following manner. Preferably, the producer logs in at the Product Control Home page, or any other log in page, as best seen in FIGS. 10 and 11. Preferably, and as best seen in FIG. 22, should the producer be associating a product with a particular media for the first time, then the producer may be directed to establish ownership of that particular media. The producer's ownership of the particular media may be verified by the administrator of the website. In this manner, only producers that establish ownership of the particular media and/or other authorized entities, may associate product with the particular media. In other embodiments, the producer is not directed to establish ownership and/or any entity may associate product with a particular media.

In a preferred embodiment, the producer be given the option of creating a new product list or choosing from an existing one. Should the producer select “create a new product list” then the producer may enter details of the particular media that is associated with the products he or she is intending to offer for purchase. A new media item, having the information regarding the particular media, is created, and is added to the media database. Preferably, the producer may enter information regarding the new products and associate those products with the new media. These new products are added to the products database. Should the producer select “choose from an existing media list” then the producer is provided with a list of existing media, created by the producer and/or others. The producer may be able to choose from one of the media, and may further choose from a sub-list of particular media, and associate that product with that particular media. In other embodiments, the producer does not need to log in.

In a preferred embodiment, and as based seen in FIGS. 18-20, the particular media may be marked with an identification, alerting the viewer to the fact that one or more products viewed in the media may be available for purchase on the website and/or may provide the user with a website to go to. That identification may be a mark/watermark on the particular media or embedded in the particular media. The mark/watermark may be a hyperlink to the website of the subject invention. For example, should a producer of an on-line video decide to offer for sale some of the products in the video itself on the website, then the producer may add a tag or some sort of identification alerting viewers to the fact that one or more products in the video itself are available for sale by accessing the website. As such, the producer is provided with a means for adding an identification to the video that notifies the viewer that one or more products seen in the video may be purchased by accessing a computerized electronic server. For example, as seen in FIGS. 18-20 on the lower left of the on-line video, a watermark may be added. Additionally, the watermark may be added to any other media, such as a television show or a video that is not on-line. In other embodiments, the mark/watermark may be on or near the product itself, and the user may be able to just click the mark/watermark to purchase the product. In this manner, the user may click the watermark and purchase the product, for example, on the television set without the Internet. In other embodiments, an identification is not added to the particular media.

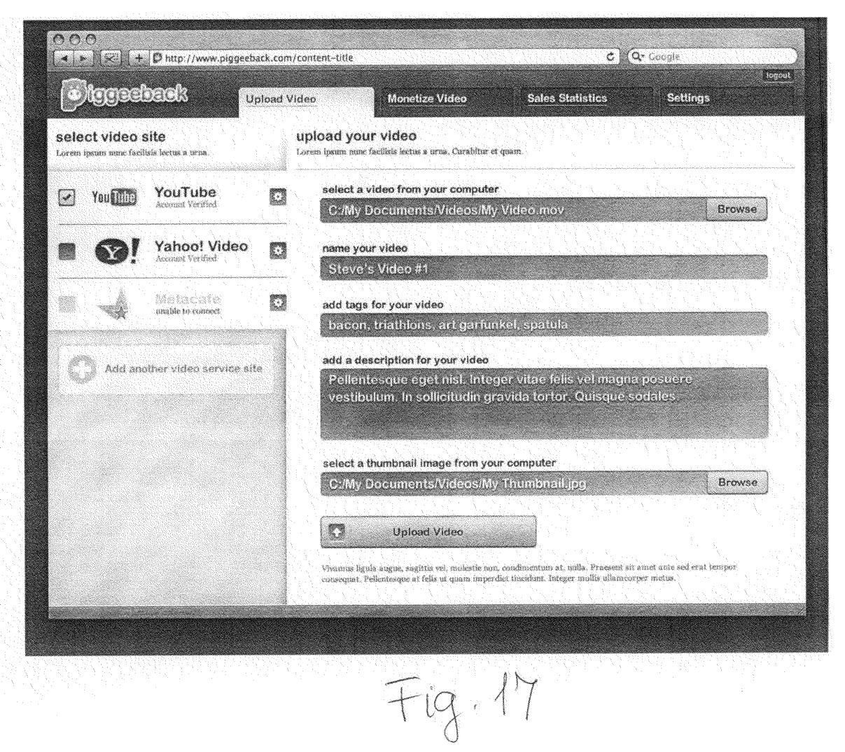

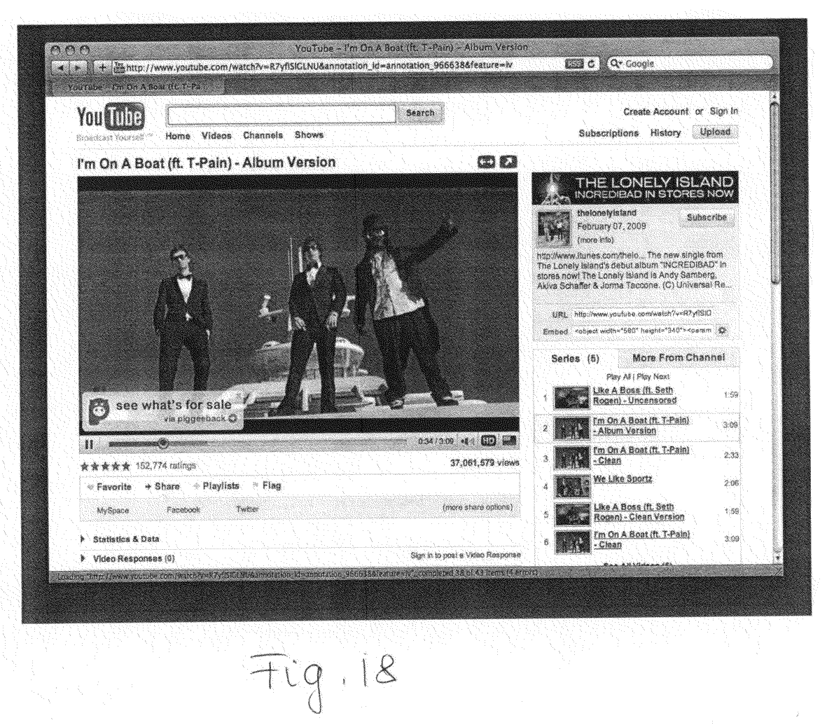

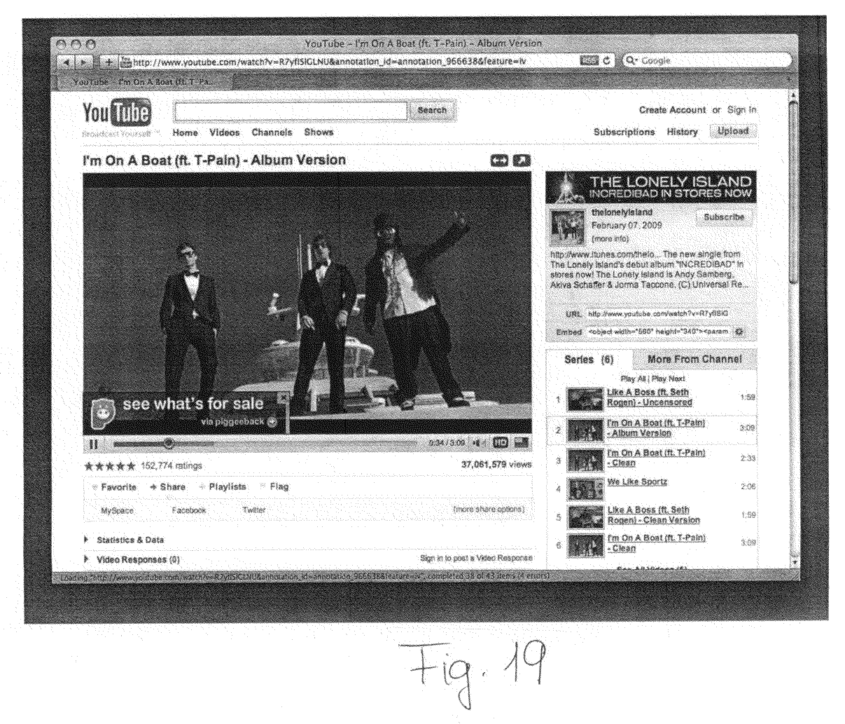

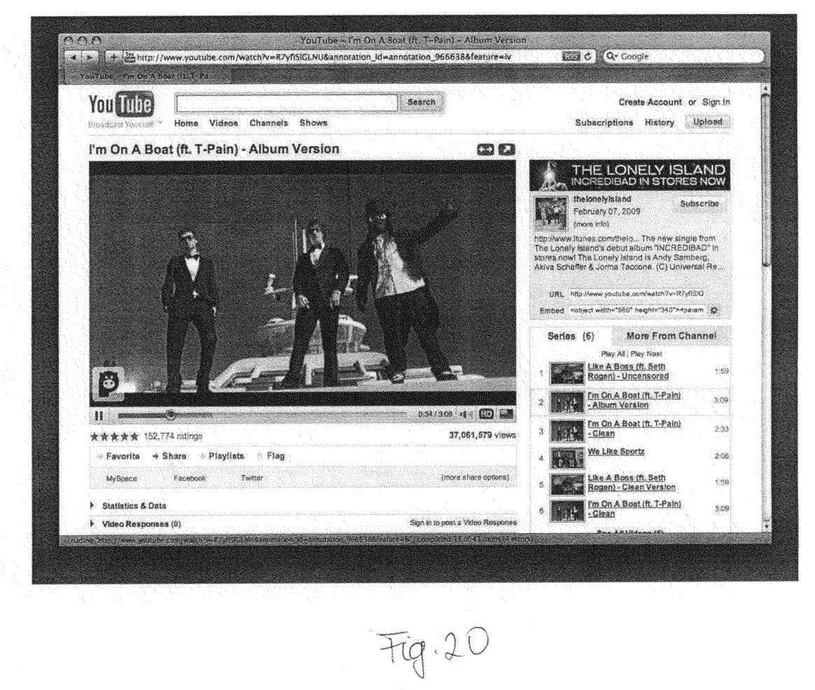

In a preferred embodiment, should the media be on-line video, it may be uploaded into the website of the present invention, as well as associated with a product list, in the following manner. Referring to FIG. 21, for example, a producer selects one or more on-line videos to upload from a file system, and one or more video services. Preferably, the video service may input video metadata into the on-line video. Thereafter, the on-line video is uploaded onto the web server of the present invention, as best seen in FIGS. 16 and 17. Preferably, a list of the producer's on-line videos, in the form of thumbnails or the like, are displayed on the website of the present invention, as shown in FIG. 12. The producer may select a video to monetize and/or associate with a plurality of products. For example, should the producer select video #1 to monetize and/or associate with products, a screen such as the one depicted in FIG. 13 having the selected video in a box may be displayed on the device. The producer may search his or her product lists and/or any other lists that he or she has authorization to access and may drag products that he or she would like to associate with the particular video into the box with the video, as shown in FIG. 14, wherein a car and a watch, amongst other products, are associated with the particular video. Additionally, the producer may be able to search the system for one or more products using a general search function as depicted in FIG. 15.

In a preferred embodiment, for example, a producer and/or video service provider may create an embedded tag on the on-line video. This embedded tag may be comprised of a unique serial number associated with that video. A unique video serial number is created, and the producer may associate his or her on-line video with that unique video serial number. The producer may enter the tag number into the media database. Subsequently, a user watching the video and desiring to purchase one or more items seen in the video, may be able to retrieve the embedded tag from the on-line video itself and search the website using the on-line video's embedded tag. In addition, the producer may be able to associate certain products seen in the on-line video with unique product serial numbers. These product serial numbers may be associated with the video's embedded tag. In other embodiments, embedded tags, or other forms of identification, associated with other particular media may be used to search the website. For example, a user watching a movie may use an identification associated with the movie to search the website for products associated therewith.

In a preferred embodiment, the user may be able to search for a product based upon its bar code number. In a like manner, a producer may be able to search the product data base for a product based upon its bar code number.

In another preferred embodiment, and as best shown in FIG. 23, a reseller, producer, and/or user may search products in the product database for sale on the website of the present invention without associating the products with a particular media. In this way, for example, the user may search the system using a general search function, a bar code number, and/or any other production identifier to retrieve and/or purchase products of interest.

In another preferred embodiment, a user may not purchase the product of interest from the website directly. For example, the user may have seen a movie having a product of interest. The user may search the product database of the subject invention. The database may provide information to the user that the product of interest is available locally. As such, rather than purchase the product on-line, the user may head to the reseller's brick and mortar store to purchase the product. Preferably, the user's purchase, after logging on to the website, may be tracked in the following manner. The website of the present invention may provide the user with a mall or other general location where the product is located. The user may be directed to a kiosk or the like in the mall and would receive details of the of the location where the product may be purchased along with, for example, a physical or electronic receipt. The kiosk may have a computer or other device that connects electronically with the website of the present invention. Preferably, the user presents the receipt at the store when purchasing the product. In this manner, the purchase is tracked. Additionally, the receipt may include a discount or other incentives. The referral details may be scanned or entered and the information returned electronically from the reseller to the website of the present invention. In other embodiments, the user may print out and/or retrieve his own receipt from the website and take the receipt to a store, bypassing the kiosk or the like.

In a preferred embodiment, the user may search the database for the product of interest, and a bar code or other product identification and/or location where the product may be available for purchase may be retrieved from the system of the present invention. This bar code and/or product identification may be stored on the user's device and/or his or her profile on the website. Subsequently, the user may provide the reseller with this bar code and/or product identification. As such, a connection between the website of the subject invention and the purchase of the product may be established. Additionally, information regarding discounts and the like may also be transmitted or directed from, for example, the television commercial or program to the user's device. This may be in the form of a bar code or other identification. This information may be taken to the reseller's store for redemption, possibly analogous to a loyalty card.

The following examples are presented to enable those skilled in the art to understand and practice the invention and to identify the presently preferred embodiments thereof. These examples are provided for illustrative purposes and not to indicate the scope of the invention which is defined only by the appended claims.

### Example 1

A user is watching a television show. The user sees a product of interest, i.e., a jacket worn by one of the actors on the show. The user uses his or her or remote control to access a computerized electronic server on the television set itself and logs into the website. The user's location is already stored. Accordingly, a list of television service providers based upon the user's location is displayed. The user selects the television service provider, i.e., Direct TV, and a channel list is displayed based upon the selected television service provider. The user selects the channel (i.e., MTV) that he or she is watching having the show with the jacket of interest. Based upon the local time at the location of the user, a product category list is displayed. The user selects “in the television show” and a product list is displayed. Upon selection of the jacket of interest, a reseller list is displayed. The user selects a reseller of interest (i.e., GAP, OLD NAVY, MACY′S), and is directed to the reseller's website to consummate the purchase.

### Example 2

A user is watching a concert. While at the concert, a user is viewing football on a hand-held television device. The user decides that he are she wants to purchase the shirt that the lead singer of the band is wearing, as well as a tailgate item shown on a commercial on the football show. The user then uses his or her IPOD or other device to connect to an electronic system such as a website on the Internet. The user then logs into the website, enters his or her location, and is provided with a media list. The user then selects “live events” and is directed to a sub-list of “live events.” From the sub-list, the user selects “concerts” and is directed to a screen with a list of concerts happening at that particular day/time. The user selects the concert he or she is at, and is provided with a product list. If the shirt of interest is on that list, the user can purchase it. Additionally, the user can go back to the screen displaying the media list to purchase the tailgate product by selecting “television or commercial,” entering or selecting a television service provider, selecting a channel, and selecting “in the commercial.” In this manner, the user is able to purchase a plurality of products from a plurality of media simply by accessing one electronic server. Additionally, the products can all be purchased at about the same time.

### Example 3

A user watched the television show, So You Think You Can Dance. Two weeks later, the user decides to purchase the dress the hostess was wearing. The user uses his or her IPOD to connect to an electronic system such as the Internet. The user logs into the system. The user enters the time when he or she watched television show, and a media list is displayed. The user selects the television show of interest, and is directed to a product list. Should the user find the dress of interest, the user may proceed to purchase the dress.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. A method for providing to a user a single source for ordering a plurality of products from a plurality of media comprising:
(a) providing a computerized electronic server for ordering products;
(b) providing a means for selecting one or more media from a list of media;
(c) providing a list of products associated with the selected media;
wherein the computerized electronic server is accessible via a device.

2. The method of claim 1, wherein the list of media is associated with the geographic location of the user.

3. The method of claim 1, wherein the device is selected from the group consisting of a computer, television set, remote control, or a hand-held electronic device.

4. The method of claim 1, wherein the computerized electronic server is a website.

5. The method of claim 1, wherein the media is selected from the group consisting of feature film, television show or commercial, printed media, video, video game, and live event.

6. The method of claim 1, wherein the media list displayed on the computerized electronic server varies with local time or other time entered by the user.

7. The method of claim 1, wherein the selected media is “television show or commercial.”

8. The method of claim 7, further comprising the step of providing a television service provider list based upon the selection of “television show or commercial.”

9. The method of claim 8, further comprising the step of providing a channel list based upon the selected television service provider.

10. The method of claim 9, further comprising the step of providing a program list based upon the selected channel.

11. A method of providing a single source for ordering a plurality of products seen by a user in a plurality of television shows or commercials by accessing a single computerized electronic server, comprising:
(a) providing a computerized electronic server for ordering a plurality of products seen by the user;
(b) providing a television service provider list;
(c) providing a channel list based upon the selected television service provider; and
(d) providing a product list upon the selected channel;
wherein the computerized electronic server is assessable via a device of ordering a plurality of products and wherein the products are available for selection by the user as the user is watching the television show or commercial that contains the product of interest.

12. The method of claim 11, wherein the television service provider list is based on the geographic location of the user.

13. The method of claim 12, further comprising the step of providing a means for entering geographic location of the user after the step in (a).

14. The method of claim 13, wherein the product list is based upon local time or other time entered by the user.

15. A system of providing a single source for the purchase of a plurality of products seen by a user in one or more media as the user is viewing the media or anytime thereafter, comprising:
(a) a database of media;
(b) a database of products associated with the media;
(c) a software system for selecting a plurality of products viewable in the media; wherein the software system
(i) provides a media list, and
(ii) provides a product list based upon a particular media selected.

16. The system of claim 15, wherein the media list is based upon the geographic location of the user.

17. The system of claim 16, wherein the software system provides a producer an option of creating a new product list or altering an existing one.

18. The system of claim 17, wherein the software system provides the producer an option of adding a new media to the existing media list should the producer choose to create a new product list.

19. The system of claim 18, wherein the new media is a video, and wherein the producer is provided with a means for adding an identification to the video that notifies the user that one or more products in the video may be purchased by accessing a computerized electronic server.

20. The system of claim 15, wherein the computerized electronic server is a website.

21. The system of claim 20, wherein the website displays the media list and the product list.

22. The system of claim 15, further comprising a device for recognizing bar codes.

23. The system of claim 22, wherein the software system identifies the product based upon a bar code number.

24. The system of claim 24, wherein the user can search the database of products based upon bar code number.

25. The method of claim 1, further comprising the step of providing a means for selecting a plurality of products from the product list.

26. The method of claim 25, further comprising the step of providing a list of resellers based upon the products selected by the user.

27. The method of claim 26, further comprising a means of selecting a reseller from the list of resellers;
wherein the user is redirected to the selected reseller's website; and wherein information regarding the user's purchase of the products from the reseller's website is provided to the first website.

28. A method of providing information regarding the purchase of a plurality of products from a reseller's website to a first website, comprising:
(a) providing a first website for ordering a plurality of products, wherein the first website is accessible using a device capable of connecting to the Internet,
(b) displaying a plurality of resellers on the website, wherein each reseller's website is accessible from the first website via a link, and
(c) collecting a data packet when a user is redirected to a reseller's website by clicking on the link, wherein the data packet comprises information regarding the product of interest, the user's Internet Protocol address, and the date and time of the redirection, and, wherein the data packet is stored in the first website.

29. The method of claim 28, wherein the reseller's website notifies the first website when the user purchases the product of interest.

30. The method of claim 29, wherein the notification includes information regarding the product sold.

31. The method of claim 30, wherein the data packet comprises the product's unique identification number.

32. A method comprising the steps of:
(a) viewing a first particular media,
(b) viewing a first product within the first particular media,
(c) accessing a website via a device, wherein the first product is associated with the first particular media on the website, and
(d) purchasing the first product via the first website.

33. The method of claim 32, wherein the device is selected from the group consisting of computer, hand-held electronic device, television set, and remote control.

34. The method of claim 32, further comprising the step of selecting the first particular media from a list of media after the step in (c).

35. The method of claim 35, wherein a second product is associated with a second particular media on the website.

36. The method of claim 10, wherein a product list is displayed based upon the selected program.
